(19) United States
(12) Patent Application Publication
(10) Pub. No.: US 2024/0216756 A1
(43) Pub. Date: Jul. 4, 2024

(54) System for Tracking and Analyzing Sports-Related Objects and Methods of Use Thereof

(71) Applicant: DivotIsland, LLC, Prosper, TX (US)

(72) Inventors: Blake Jones, Prosper, TX (US); Brian Simmons, Oklahoma City, TX (US); Jong Sang Youn, Suwon-si (KR); Young Hwan Youn, Seongnam-si (KR)

(73) Assignee: DivotIsland, LLC, Prosper, TX (US)

(21) Appl. No.: 17/980,450

(22) Filed: Nov. 3, 2022

Related U.S. Application Data
(60) Provisional application No. 63/275,303, filed on Nov. 3, 2021.

(51) Int. Cl. A63B 24/00; A63B 71/06; A63B 102/32

(52) U.S. Cl. CPC A63B 24/0003; A63B 71/0622; A63B 2102/32; A63B 2220/12; A63B 2220/30; A63B 2220/40; A63B 2220/806; A63B 2220/89; A63B 2225/50

(57) ABSTRACT

A golfing analysis system capable of tracking and analyzing golf ball, golf club, and/or golf swing operations by sensing different types of motion in parallel and combining separate readings to provide highly accurate golfing data and simulations, regardless of the user's operating environment or sporting equipment. In one embodiment, the system comprises a motion measuring device disposed on an operator or operator's equipment, a speed measuring device disposed at a distance from the operator and the motion measuring device, and an external application. The motion measuring device comprises an inertial measurement unit (IMU), a microprocessor, and a communications unit and the speed measuring device comprises a radar sensor, a camera sensor, a remote GPS sensor, and a display unit.

### CROSS-REFERENCE TO RELATED APPLICATIONS

This application is a non-provisional application that claims the benefit of U.S. Application Ser. No. 63/275,303 filed Nov. 3, 2021, the disclosure of which is incorporated by reference herein in its entirety.

### STATEMENT REGARDING FEDERALLY SPONSORED RESEARCH OR DEVELOPMENT

Not applicable.

### BACKGROUND OF THE INVENTION

### Field of the Invention

The present invention relates to a sports analysis system capable of tracking and analyzing sports-related objects and/or body movement. More particularly, the present invention relates to a golfing analysis system comprising multiple devices capable of tracking and analyzing golf ball, golf club, and/or golf swing operations by sensing different types of motion in parallel and combining separate readings to provide highly accurate golfing data and simulations, regardless of the user's operating environment or sporting equipment.

### Background of the Invention

Sports analysis systems, particularly golfing analysis systems, may comprise conventional analysis equipment such as, without limitation, sensors, radars, cameras, monitors, projectors, and other equipment to provide golfing data and/or golfing simulations to a user. Currently, sensor-based sports analysis systems with accelerometers and gyroscopes may be known and used to sense, record, and monitor sports movements and physical positions in space relative to a reference point. However, an accelerometer/gyroscope combination sensor may only sense sports movement in reference to its installation point and/or its starting reference point. As such, sensor-based golfing analysis systems capable of sensing a swing and deriving ball outputs (e.g., distance, spin, angles, etc.), may only be accurate to a certain resolution. Consequently, these systems generally represent a lower tier of golf ball simulation products and sports movement detection equipment.

In an alternative approach, radar-based sports analysis systems with one or more radars may be known and used to detect velocities and/or speeds related to the execution of sports movements. As such, radar-based golfing analysis systems, utilizing simulation software, may be capable of plotting out a trajectory path for a golf club, golf ball, and/or golf swing, as well as providing an analysis of the movement of the golf club, golf ball, and/or golf swing. Low-end models of radar-based sports analysis systems often utilize a single-channel radar which, despite providing accurate measurements, may be limited in the number of velocity and/or speed values capable of being measured. Generally, in order to fully sense/detect sports movements and thereby generate a complete analysis of the sports movements, a radar-based analysis system may need to utilize a multi-channel radar (typically comprising three or more channels). With an increased number of channels, a multi-channel radar may be capable of measuring a greater number of velocity and/or speed values than that of the single-channel radar, and thereby may yield more accurate results. Consequently, radar-based analysis system that utilizes a multi-channel radar may be the method of detection for mid- to high-tier sports movement detection equipment, however such analysis systems may come at significant cost premiums compared to lower-tier equipment.

Regardless of the type, whether sensor-based or radar-based, current golfing analysis systems may require special installation that depends on the operating environment, such as an indoor or outdoor environment. Furthermore, current golfing analysis systems may require the use of particular golfing equipment, such as a real or special golf ball or golf club. As an example, current golfing analysis systems used in indoor golfing simulations often require certain analysis equipment to be installed in a specific configuration based on a room's size or dimensions and may require the use of a special golf ball to provide accurate results. All these shortcomings of current golfing analysis systems, ultimately increase the expense of current golfing analysis systems as well as limit current systems' mobility, versatility, accuracy, and functionality.

Consequently, there is a need for an improved golfing analysis system capable of tracking and analyzing golf ball, golf club, and/or golf swing operations by sensing different types of motion in parallel and combining separate readings to provide highly accurate golfing data and simulations, regardless of the user's operating environment or sporting equipment.

### BRIEF SUMMARY OF SOME OF THE PREFERRED EMBODIMENTS

These and other needs in the art are addressed in one embodiment by a system comprising a motion measuring device disposed on an operator or operator's equipment, a speed measuring device disposed at a distance from the operator and the motion measuring device, and an external application. The motion measuring device comprises an inertial measurement unit (IMU), a microprocessor, and a communications unit and the speed measuring device comprises a radar sensor, a camera sensor, a remote GPS sensor, and a display unit.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a golfing analysis system in accordance with embodiments of the present invention;

FIG. 2 illustrates a block diagram that represents a motion measuring device in accordance with embodiments of the present invention;

FIG. 3 illustrates a block diagram that represents a motion measuring device in accordance with alternative embodiments of the present invention;

FIG. 4 illustrates a block diagram that represents a speed measuring device in accordance with embodiments of the present invention;

FIG. 5 illustrates a rear view of a speed measuring device in accordance with embodiments of the present invention;

FIG. 6A illustrates an embodiment of a motion measuring device.

FIG. 6B illustrates an alternative embodiment of a motion measuring device.

FIG. 7A illustrates a front view of an embodiment of a mount accessory.

FIG. 7B illustrates a rear view of an embodiment of a mount accessory.

FIG. 7C illustrates a front view of a mount accessory being utilized by a speed measuring device in accordance with embodiments of the present invention.

FIG. 7D illustrates a rear view of a mount accessory being utilized by a speed measuring device in accordance with embodiments of the present invention.

FIG. 8A illustrates a top perspective view of a speed measuring device utilizing magnets for mounting purposes in accordance with embodiments of the present invention.

FIG. 8B illustrates a bottom perspective view of a speed measuring device utilizing magnets for mounting purposes in accordance with embodiments of the present invention.

### DETAILED DESCRIPTION OF THE PREFERRED EMBODIMENTS

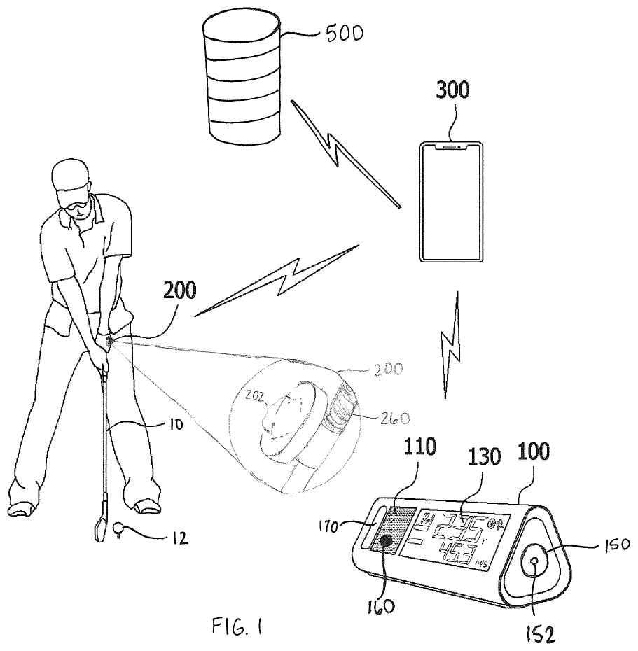

FIG. 1 illustrates an embodiment of a golfing analysis system capable of tracking and analyzing golf ball, golf club, and/or golf swing operations. In embodiments, the golfing analysis system may comprise a speed measuring device 100 and a motion measuring device 200, each of which may carry out individual processes and techniques that may be combined to provide a high-resolution (i.e., highly accurate) golfing analysis at a comparatively lesser expense. This high-resolution golfing analysis may comprise accurate values for golfing metrics such as, without limitation, swing distance, head speed, tempo, club path direction, club path, face angle direction, face angle, swing type, club release late (CRR) or rate of closure (RoC), ball speed, smash factor, and sensor speed, all of which may be transmitted to an external application 300. In further embodiments, the golfing metrics may further comprise vertical launch angle, launch direction, launch direction angle, and ball distance.

In embodiments, motion measuring device 200 of the golfing analysis system may be a device for installation onto a golf club 10 at any suitable position, or alternatively onto a glove/hand of a user of golf club 10 at any suitable position, thereby allowing for sensing of three-dimensional movement of golf club 10 through space during operation as well as any metrics related to such movement. In order to aid in the installation of motion measuring device 200 onto golf club 10 or onto the glove/hand of the user of golf club 10, motion measuring device 200 may comprise a rapid release mount 260 that allows for both installation and removal at a suitable position. In embodiments, motion measuring device 200 may further comprise a magnet or magnets for anchoring motion measuring device 200 to metallic objects such as a golf cart or rapid release mount 260 itself. The magnet or magnets may comprise neodymium magnets. In embodiments, a suitable position for motion measuring device 200 may be below a grip of golf club 10, which may allow the motion measuring device 200 to capture reference points along a larger arc path than if it were installed at the top of golf club 10 (i.e., on the top of a shaft or the grip of golf club 10). Further, when motion measuring device 200 may be installed below the grip of golf club 10, motion measuring device 200 may achieve more accurate results with a relatively low sampling rate. In embodiments, golf club 10 may be a real golf club of any type and/or size, or alternatively may be a golf club-emulating object or shaft. In some embodiments, golf club 10 may be a telescopically extending “in home” simulation swing stick. In operation, the golfing analysis system may be equipped with the necessary hardware and software that allows the user to specify the type and/or sized golf club 10 being used.

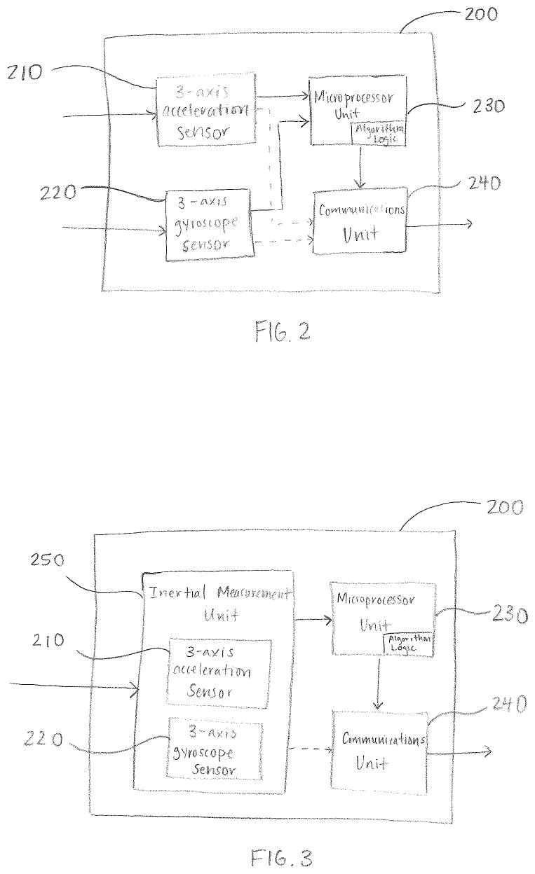

In order to accomplish said sensing of golf club 10, motion measuring device 200 may comprise a 3-axis acceleration sensor or accelerometer 210, a 3-axis gyroscope sensor 220, a microprocessor 230, and a communications unit 240, as is illustrated in FIG. 2. Alternatively, as illustrated in FIG. 3, motion measuring device 200 may comprise an inertial measurement unit (IMU) sensor 250, microprocessor 230, and communications unit 240, wherein IMU sensor 250 comprises 3-axis acceleration sensor 210 and 3-axis gyroscope sensor 220. In further embodiments, motion measuring device 200 may comprise a magnetometer in addition to the other sensors.

In embodiments, 3-axis acceleration sensor 210 may be capable of measuring acceleration values of golf club 10 in each of the three axes during operation or when in a swinging motion. Further, 3-axis gyroscope sensor 220 may be capable of measuring rotational speed values of golf club 10 in each axis during operation or when in a swinging motion. For instance, acceleration values (ax, ay, az) and rotational speed values (wx, wy, wz) in (x, y, z) may be continuously measured during operation of golf club 10. In embodiments, such measurements may be utilized by microprocessor 230 of motion measuring device 200 to calculate and/or provide various golfing metric values, whereby microprocessor 230 may employ various algorithms on the acceleration measurements provided by 3-axis acceleration sensor 210 and/or the rotational speed measurements provided by 3-axis gyroscope sensor 220. Additionally, microprocessor 230 may utilize data related to orientation of golf club 10 at a point of impact with a golf ball 12, or alternatively, at a point where impact may be estimated should golf ball 12 not be present. As such, microprocessor 230 may be capable of determining the swing distance, tempo, club path direction, club path, face angle direction, face angle, swing type, sensor speed, a face angle value, and ball speed when putting.

In embodiments, the face angle value may be obtained by analyzing the acceleration value (ay) in the horizontal axis (y) direction as well as the rotational speed value (wz) in the shaft axis (z) direction/in the gravitational acceleration direction at an initial point of a golf swing (i.e., a point in time in which each measurement value for motion measurement device 200 may be “0”) and the point of impact during the golf swing (i.e., a point in time in which golf club 10 makes contact with golf ball 12, which may further be specified as a point in time in which maximum velocity of golf club 10 occurs during the golf swing). By integrating and calculating the amount of change between these two points, the face angle value of golf club 10 at the time of hitting golf ball 12 may be calculated.

In embodiments, the club path value may be obtained by calculating a vector sum of the acceleration value (ay) in the horizontal axis (y) direction and the acceleration value (ax) in the vertical axis (x) direction at the point of impact during a golf swing. In some embodiments, the club path value may be an angle value on the xy-plane as it relates to direction of movement of golf club 10 at the point of impact with golf ball 12.

In embodiments, a vertical attack angle value may be obtained by calculating a vector sum of the acceleration value (ay) in the horizontal axis (y) direction and the acceleration value (az) in the shaft axis (z) direction at the point of impact of a golf swing. In some embodiments, the vertical attack angle value may be an angle value on the yz-plane as it relates to direction of movement of golf club 10 at the point of impact with golf ball 12. In further embodiments, the vertical attack angle value may be utilized to calculate a launch angle value.

In addition to the above values, a side spin value of a hit golf ball 12 may be obtained based on the calculated face angle value and club path value. More specifically, the side spin value may be calculated as 0 when the difference value (D) between the face angle value and the club path value may be 90°. Although, if the difference value (D) between the face angle value and the club path value exceeds 90°, a certain amount of side spin in the clockwise direction may be calculated, with an excess value being the degree to which the difference value (D) exceeds 90°. Alternatively, if the difference value (D) between the face angle value and the club path value is less than 90°, a certain amount of side spin in the counterclockwise direction may be calculated with the lacking value being the degree to which the difference value (D) is less than 90°.

Further, top spin or back spin of a hit golf ball 12 may be obtained based on the calculated vertical attack angle value. More specifically, when a positive vertical attack angle value may be calculated, the hit golf ball 12 may be determined as having top spin. Further, the amount of top spin may be calculated so as to be proportional to the absolute value of the vertical attack angle value. Alternatively, when a negative vertical attack angle value may be calculated, the hit golf ball 12 may be determine as having back spin. Similarly to the amount of top spin calculation, the amount of back spin may be calculated so as to be proportional to the absolute value of the vertical attack angle value.

In embodiments, the face angle direction may be obtained from the calculated face angle value. The face angle direction may be the direction the clubface of golf club 10 may be oriented at the point of impact. Further, the club path direction may be obtained from the calculated face angle value. With the club path direction, a starting direction of a hit golf ball 12 may be obtained, and further with the club path direction and the calculated face angle value, a launch direction of a hit golf ball 12 may be obtained.

In operation, motion measuring device 200 may begin sensing operations when activated by the user via selection buttons 202. Further, selection buttons 202 may be used to facilitate the selection of the type of golf club 10 being used in operation. In embodiments, golf club selection capabilities may allow for calculations performed by motion measuring device 200 as well as speed measuring device 100 to result in accurate golfing metric values. As an example, the user of the golfing analysis system may select an iron versus a 3-wood, or alternatively select golf clubs that are cavity backed, or further alternatively select clubs of various blade types. In such embodiments, the user may input the type of club being used and the level of specification desired (e.g., user accepts general club lofts, user measures and inputs all values manually, or user is assisted with camera technology on a smartphone to find lofts). In some embodiments, golf club selection capabilities may also be accomplished via speed measuring device 100 or external application 300.

In embodiments, any golfing metric values obtained and processed by microprocessor 230 may be transmitted to external application 300 via communications unit 240. Communications unit 240 may be a wireless communication system utilizing radio, Bluetooth, and/or Wi-Fi communication. In some embodiments, the golfing metric values transmitted by communications unit 240 may be dependent upon the activation status of microprocessor 230. For instance, when microprocessor 230 may be selectively deactivated, communications unit 240 may only transmit the following values to external application 300: acceleration values measured by 3-axis acceleration sensor 210 and rotational speed values measured by 3-axis gyroscope sensor 220. Alternatively, when the microprocessor 230 may be selectively activated to fully perform its functions, communications unit 240 may transmit the following data, without limitation, to external application 300: swing distance, tempo, club path direction, club path, face angle direction, face angle, swing type, a face angle value, ball speed when putting, the spin values, and launch direction of hit golf ball 12.

In embodiments, referring once again to FIG. 1, speed measuring device 100 of the golfing analysis system may be a device capable of measuring the velocity of golf ball 12 when hit by golf club 10. Speed measuring device 100 may be separate from, but working in conjunction with, motion measuring device 200, and further may be positioned at any suitable position in relation to motion measuring device 200, golf ball 12, golf club 10, and/or the user. In embodiments, speed measuring device 100 may comprise a single or multi-channel radar sensor 110, a camera sensor 160, a remote GPS sensor 150, a display unit 130, and one or more charging ports 170. Further, as represented in FIG. 4, speed measuring device 100 may further comprise a microprocessor 120 and a communications unit 140. ,

In embodiments, single or multi-channel radar sensor 110 may be capable of measuring velocity of golf ball 12 and/or golf club 10 during operation. Further, single or multi-channel radar sensor 110 may not require the need for any special equipment such as, without limitation, a special golf ball in order to accurately measure hit golf ball velocity. For instance, single or multi-channel radar sensor 110 may be capable of measuring the velocity of a hit golf ball 12 without the need for any type of metal material attachment on golf ball 12. In embodiments, obtained velocity measurements may be utilized by microprocessor 120 of speed measuring device 100 to calculate and/or provide various golfing metric values, whereby microprocessor 120 may employ various algorithms on the velocity measurements provided by single or multi-channel radar sensor 110. Further, microprocessor 120 may perform calculations based on or in relation to different loft values, coefficients of energy return, and/or golf club type, and thereby may be capable of determining a distance value of a hit golf ball 12, in addition to the velocity of hit golf ball 12 and/or golf club 10.

In embodiments, similarly to motion measuring device 200, any golfing metric values obtained and processed by microprocessor 120 may be transmitted to external application 300 via communications unit 140. Communications unit 140 may be a wireless communication system utilizing radio, Bluetooth, and/or Wi-Fi communication. Further, the golfing metric values obtained and processed by microprocessor 120 may be transmitted to and/or shown by display unit 130. In embodiments, display unit 130 may be an instant readout LCD disposed on speed measuring device 100. The instant readout display may be a fixed-output, high-visibility LCD hardwired into speed measuring device 100 without the need for connection to an application. Further, golfing metric values output by display unit 130 may comprise, without limitation, ball speed in mph and/or m/s, club head speed in mph and/or m/s, algorithmic distance calculations, or any combinations thereof.

In some embodiments, speed measuring device 100 may further comprise camera sensor 160. Camera sensor 160 may capture images and or record videos of the user's swing operation, and thereby provide additional swing analysis data to be processed by microprocessor 120. In embodiments, the images captured or videos recorded by camera sensor 160 may be used to aid in the determination of swing analysis data such as, without limitation, the launch angle or the directional angle of golf ball 12, thus providing increased accuracy. In addition, speed measuring device 100 and/or motion measuring device 200, both of which are capable of sensing and monitoring movement via sensors and single or multi-channel radar 110 may trigger camera sensor 160 to begin recording upon sensing motion from an operator.

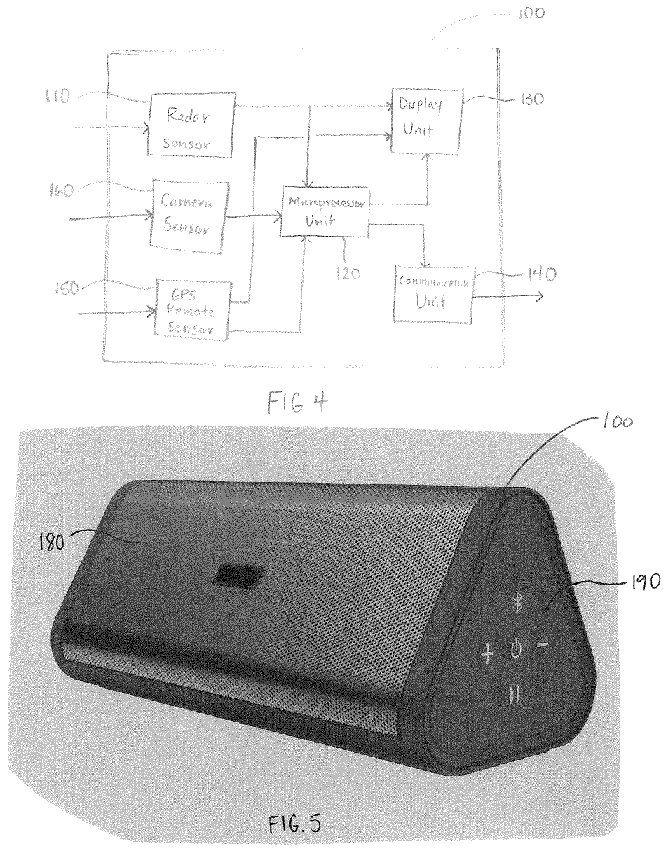

In embodiments, speed measuring device 100 may further comprise remote GPS sensor 150 for determining position of the golfing analysis system or the user on an actual golf course. Remote GPS sensor 150 may be a GPS-enabled sensor detachable from speed measuring device 100, wherein attachment and detachment of the GPS sensor 150 may be accomplished via magnets. This detachability allows remote GPS sensor 150 to be carried by, pocketed by, or attached to the user of the golfing analysis system. In such embodiments, remote GPS sensor 150 may be used in conjunction with geographical, dimensional, or GPS data of one or more golf courses stored by the golfing analysis system to determine positioning of remote GPS sensor 150, and by extension the user, on a selected golf course. In determining the positioning of the user on the selected golf course, the golfing analysis system may be capable of determining distances the user may be from the hole, the green, and/or other landmarks on the selected golf course. In embodiments, remote GPS sensor 150 may comprise an activation button 152, that when pressed, prompts the golfing analysis system, and more specifically speed measuring device 100, to transmit a voice notification of the determined distances to the user via one or more speakers 180 of the speed measuring device 100 as illustrated in FIG. 5.

As further illustrated in FIG. 5, speed measuring device 100 may comprise control buttons 190 comprising, without limitation, a power button, a Bluetooth connectivity button, a play/pause button, and volume up/down buttons. The power button may be capable of powering speed measuring device 100 on and off. The Bluetooth connectivity button may facilitate the connecting of speed measuring device 100 to an external Bluetooth-enabled device such as, without limitation, external application 300, motion measuring device 200, or any combinations thereof. The play/pause button may be capable of playing or pausing any sound being transmitted through one or more speakers 180 such as, without limitation, music or voice notifications.

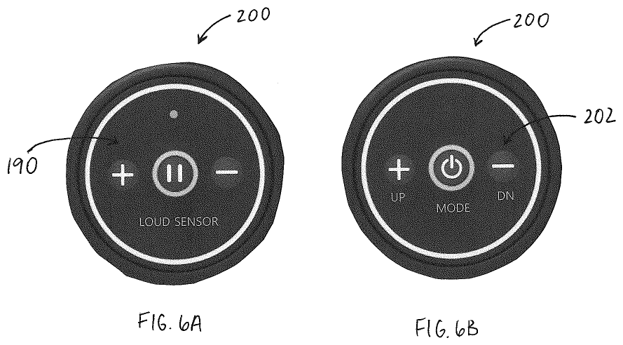

In some embodiments, control buttons 190 and/or the remote GPS sensor 150 may be incorporated into motion measuring device 200 as a single unit instead of the speed measuring device 100. In such embodiments, motion measuring device 200 may comprise selection buttons 202, activation button 152, any of the control buttons 190, or any combinations thereof. Further, motion measuring device 200 may be capable of providing all the functionalities of speed measuring device 100, remote GPS sensor 150, and control buttons 190. FIG. 6A illustrates an example of motion measuring device 200 that may incorporate control buttons 190 and/or the remote GPS sensor 150 as well as their functionalities. FIG. 6B illustrates an example of motion measuring device 200 that may incorporate selection buttons 202.

In further embodiments, speed measuring device 100 may comprise one or more microphones (not illustrated) capable of receiving voice commands from the user. In such embodiments, the user may use voice commands to prompt speed measuring device 100 to transmit voice notifications of any golfing metric values obtained by the golfing analysis system. Further, the voice commands may be capable of facilitating various functions of the golfing analysis system such as, without limitation, music playback, golf club selection, and other settings.

These aforementioned abilities for motion measuring device 200 to process and transmit data obtained from 3-axis acceleration sensor 210 and 3-axis gyroscope sensor 220, as well as for speed measuring device 100 to process and transmit data obtained from single-channel radar sensor 110, camera sensor 160, and/or remote GPS sensor 150, may eliminate the need for a third-party software and/or hardware to process said data. For example, some 3-axis acceleration sensors or accelerometers, 3-axis gyroscope sensors, or single-channel radar sensors send raw data values continuously or in bursts to a computer, smartphone, or other device that may be using simulation software, and the raw data must be processed “off chip” to derive ball flight, spin, or any other type of movement output data. However, 3-axis acceleration sensor 210, 3-axis gyroscope sensor 220, and single or multi-channel radar sensor 110 may do all calculations “on chip,” and in turn send trajectory data to third-party software or external application 300. This does not require significant additional processing of the sensors recorded data, and therefore, by using this method, trajectories may be quickly interpretated, and golf ball 12 may be seen onscreen in external application 300 in approximately 150 milliseconds.

In embodiments, the golfing analysis system may be portable as well as functional in various environments, including indoor and outdoor environments. To facilitate said portability and functionality, both motion measuring device 200 and speed measuring device 100 of the golfing analysis system may comprise respective power bank units (not illustrated) to provide power to each device and facilitate their functionalities. Each power bank unit may comprise any suitable number of batteries, of any suitable type or size. For instance, each power bank unit may be rechargeable. In embodiments, one or more charging ports 170 may be used to charge the power bank unit of speed measuring device 100. Further, both motion measuring device 200 and speed measuring device 100 of the golfing analysis system may be waterproof, thus allowing functionality in potentially wet environments. In embodiments, waterproof rating of motion measuring device 200 and speed measuring device 100 may be an IP55 rating.

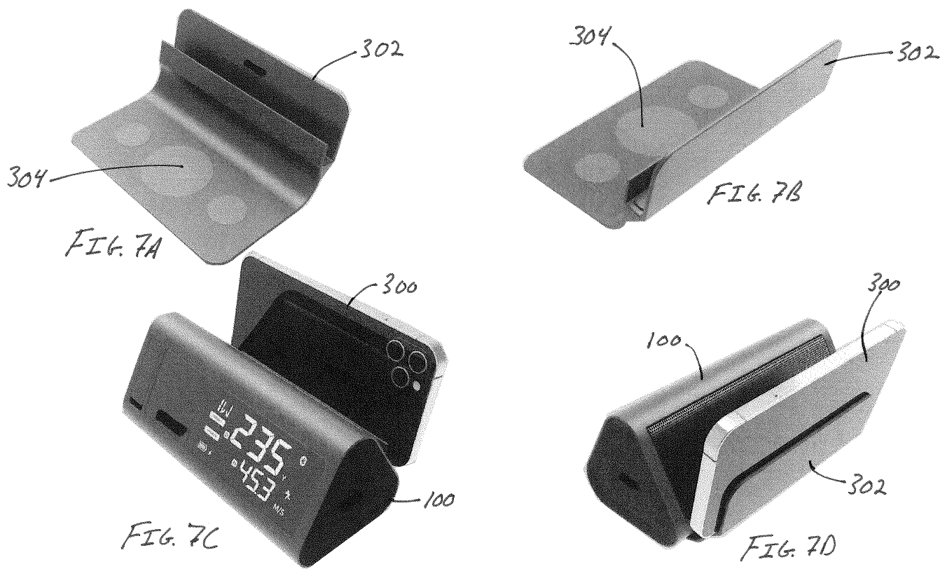

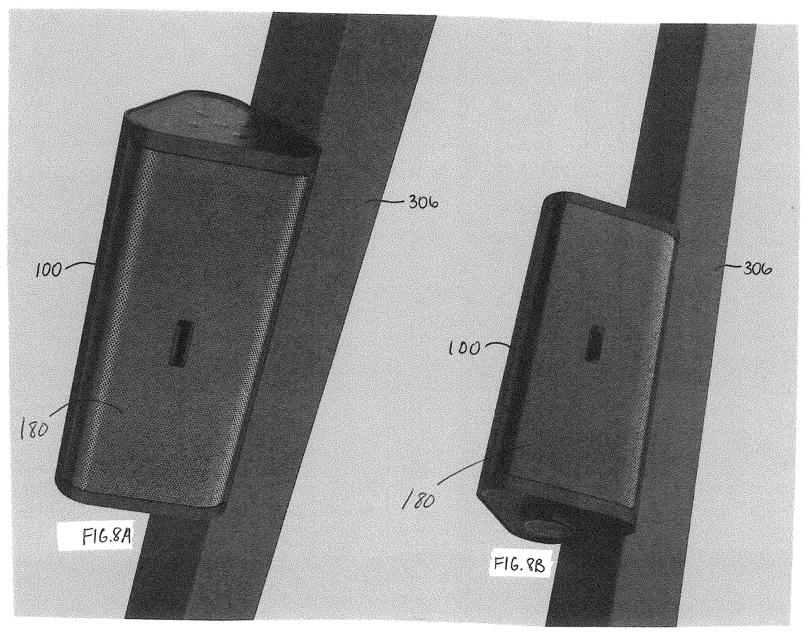

In further embodiments, referring once again to FIG. 1, external application 300 may be a mobile device, smartphone, tablet, laptop computer, personal computer with any suitable external monitor such as a computer monitor, television screen, or projector/projector screen. External application 300 may comprise any suitable hardware and software capable of running a program capable of receiving data from motion measuring device 200 and speed measuring device 100 and providing a simulation based on the received data. In embodiments, external application 300 may receive a golf ball speed measurement value of golf ball 12 from speed measurement device 100 and may receive a motion measurement value of golf club 10 from motion measurement device 200. In embodiments in which external application 300 may be a smartphone, the smartphone's camera may be used in conjunction with motion measuring device 200 and speed measuring device 100 to capture images and/or record video of a user's swing operation, and thereby provide and/or supplement swing operation data provided to external application 300. In some embodiments, as illustrated in FIGS. 7A, 7B, 7C, and 7D, speed measuring device 100 may be equipped with a detachable mount 302 capable of supporting external application 300, wherein attachment and detachment of mount 302 may be accomplished via magnets 304 disposed on both mount 302 and speed measuring device 100. FIG. 7A illustrates a front view of mount 302, and FIG. 7B illustrates a rear view of mount 302. Further, FIG. 7C illustrates a front view of mount 302 attached to speed measuring device 100, and FIG. 7D illustrates a rear view of mount 302 attached to speed measuring device 100. The magnets 304 disposed on speed measuring device 100 may further be used for anchoring speed measuring device 100 to metallic objects 306 (e.g., a golf cart), as illustrated in FIGS. 8A and 8B. FIG. 8A illustrates a top perspective view of speed measuring device 100 utilizing magnets 304 to attach to metallic object 306, and FIG. 8B illustrates a bottom perspective view of speed measuring device 100 utilizing magnets 304 to attach to metallic object 306.

Referring once again to FIG. 1, the golfing analysis system may further comprise a database 500 for storage and/or retrieval of any golfing metric values. As previously disclosed, motion measuring device 200 and speed measuring device 100 may be capable of measuring golf-related movements as well as processing said measurements to provide golfing metric values that may be transmitted to external application 300. In embodiments, database 500 may be capable of wireless communication with external application 300 and thereby may be capable of storing any golfing metric values provided by motion measuring device 200 and/or speed measuring device 100, or retrieving any previously stored golfing metric values. Further, database 500 may store the geographical, dimensional, or GPS data of the one or more golf courses utilized by remote GPS sensor 150.

The following description explains steps of a swing calculation algorithm for embodiments of the golfing analysis system. In embodiments, the swing calculation algorithm may be performed via IMU sensor 250 and microprocessor 230 of motion measuring device 200. IMU sensor 250 may measure angular rate, force, and sometimes magnetic field. Among the following steps, various skills may be added mathematically, with some of the various skills being those previously known in the art. In addition, speed measuring device 100 comprising camper sensor 160 may increase the accuracy of the swing calculation algorithm.

In embodiments, the swing calculation algorithm may begin in a setup-posture detection stage. In the setup-posture detection stage, motion measuring device 200 may utilize IMU sensor 250 and the acceleration of gravity to sense a user's posture, and more particularly to sense when a user has achieved a setup-posture. The setup-posture may be the posture of the user when ready to operate or swing golf club 10. In embodiments, having stored data of previously detected position values (i.e., a setup range) of an average golfer's setup-posture for each club, motion measuring device 200 may be capable of sensing when a user has achieved a setup-posture for a particular golf club 10. For instance, when motion measuring device 200 senses itself within the setup range for a selected golf club 10, the setup-posture may be detected and the swing calculation algorithm may move into a swing-start detection stage. Should the user begin to swing golf club 10 outside the swing-start detection stage, the swing calculation algorithm may remain in the setup-posture detection stage. In embodiments, in order to indicate detection of the setup-posture as well as the entrance into the swing-start detection stage, motion measuring device 200 may momentarily activate a vibration motor disposed within motion measuring device 200 and illuminate an LED disposed on motion measuring device 200.

Upon achieving a setup-posture and entering the swing-start detection stage, the swing calculation algorithm employed by motion measuring device 200 may activate an angular velocity sensor component among IMU sensor 250. Activation of the angular velocity sensor may be a separate action in order to reduce battery consumption of motion measuring device 200 as well as to manage memory of motion measuring device 200. From the swing-start detection stage onward, the swing calculation algorithm may comprise detecting each stage of a golf swing via the IMU sensor 250, wherein IMU sensor 250 accumulates any suitable swing data to be stored in memory. In embodiments, the memory utilized by microprocessor 230, or alternatively a microcontroller unit (MCU), may be any suitable size. The amount of memory may be selected so as to provide enough storage for accumulated swing data as well as to optimize the velocity of outputting the accumulated swing data. For instance, the velocity at which IMU sensor 250 analyzes and outputs the swing data may be increased or decreased depending on the selected microprocessor and available memory. In embodiments, motion measuring device 200 may utilize a 256 MB microprocessor 230 that allows IMU sensor 250 to analyze swing data in 10 ms (100 FPS), and further output the swing data in 1 ms. Utilizing a smaller 256 MB microprocessor 230 may reduce production cost and battery consumption, while having enough memory to store the swing data of a full swing. In embodiments the 256 MB microprocessor 230 may be capable of storing 2.6 seconds of swing data, which may be the calculated average swing time for an average golfer, starting from backswing to follow-through. More specifically, starting from back-swing to golf ball impact, the calculated average swing time for an average golfer may be 1.5 seconds. In alternative embodiments, IMU sensor 250 may utilize a larger microprocessor 230 comprising more memory (i.e., 512 MB or 1024 MB) that allows for the storage of more accumulated swing data. This in turn may allow the larger microprocessor 230 to store an increased duration of swing data (e.g., up to 3 seconds or 4 seconds of swing data), and thereby may increase the accuracy of IMU sensor 250 and further, the velocity at which data may be analyzed and output.

In the swing-start detection stage, the start of a golf swing (i.e., a backswing) may be detected using four conditions. The first condition may be minimum velocity of the backswing. In embodiments, when the backswing starts, velocity values may be obtained via 3-axis acceleration sensor 210 of IMU sensor 250 using integration methods on the measured acceleration values. As such, IMU sensor 250 may detect minimum velocity of the swing-start of moving golf club 10, wherein the minimum velocity may be a composite of X/Y/Z components. The second condition may be acceleration increment of the backswing. In embodiments, IMU sensor 250 may detect a specific acceleration range from the starting velocity of the backswing. The third condition may be travel distance of the backswing. In embodiments, IMU sensor 250 may be capable of determining the travel distance of the backswing, which may be monitored to distinguish a backswing from a short waggle motion. For instance, a backswing may be detected when no change in velocity direction of golf club 10 is sensed during a certain period of time. Alternatively, a short waggle motion may be detected when a change in velocity direction of golf club 10 is sensed during a certain period of time, shorter than that used to determine a backswing. Finally, the fourth condition may be velocity and acceleration of each type of golf club 10. In embodiments, average backswing velocity and acceleration may be classified and stored for each type of golf club 10 in order to increase the detection accuracy of the swing-start detection stager. For instance, since the swing-start velocity of a putter versus a driver may be different and further the angle of the setup-posture may be different, classification and storage of the average backswing velocity and acceleration may aid in the ability of IMU sensor 250 to detect the swing-start of each particular golf club 10.

In further embodiments, in the swing-start detection stage, right/left hand may be distinguished and both hands may be detected. In some embodiments, both hands may be detected by default. This distinction between right and left hands may increase accuracy of the swing-start detection stage. Overall, swing-start detection stage may be important to distinguish a golfer's backswing from a golfer's waggle motion. Further, the swing-start detection stage may include various filtering calculations to increase the accuracy of IMU sensor 250 within motion measuring device 200.

After successfully detecting a golfer's start-swing or backswing, the swing calculation algorithm may enter a swing sensing stage. Within the swing sensing stage, four swing phases must be exactly matched in order for motion measuring device 200 to recognized a swing. In the event of any deviation of the four swing phases, the swing calculation algorithm may return to any of its previous stages such as the start-swing detection stage or the setup-posture detection stage. In embodiments, the four swing phases may be divided into a top swing phase, a down swing phase, an impact phase, and a follow-though swing phase. During these swing phases, microprocessor 230 may execute swing detection logic while simultaneously storing any swing data gather by the IMU sensor 250. As new data may be added, old data may be deleted.

Although dependent on the type of golf club 10, the top swing phase may be entered when a change in velocity direction from that of the backswing is detected by IMU sensor 250. In embodiments, IMU sensor 250 may detect a sudden change in the reverse direction from a specific velocity, and further detect the range of the reverse velocity and acceleration. The down swing phase may be entered when IMU sensor 250 detects golf club 10 within a particular velocity and acceleration range, which may correspond to a previously stored average velocity and acceleration range for each type of golf club 10. The impact phase may be entered when IMU senor 250 detects maximum velocity and maximum acceleration of golf club 10, which may be distinguished as IMU sensor 250 detects continuous deceleration of golf club 10. Once again, the velocity and acceleration values for golf club 10 may be compared to the previously stored average velocity and acceleration values for each type of golf club 10, to thereby increase the accuracy of impact phase detection. In this phase, the impact point may be selected based on the maximum velocity and acceleration within a set of measured velocity and acceleration values accumulated by IMU sensor 250. In embodiments, the point of maximum velocity and acceleration within the set may be selected as the impact point. Further in this phase, the swing calculation algorithm may determine whether golf ball 12 was hit. In embodiments, to determine whether golf ball 12 was hit, displacement of the Y-axis acceleration and angular velocity during impact may be monitored. The follow-through phase may be entered when IMU sensor 250 detects a change in direction of golf club 10 after the impact point, as it relates to the Y-axis, and further that the change in direction may be continuously maintained. In embodiments, a data analysis and manipulation tool, such as Pandas, utilized by motion measuring device 200 may determine velocity and acceleration as well as the direction of angular velocity as it relates to change of axis of rotation for all swing phases. For instance, motion measuring device 200 may determine whether the angular velocity rotating in the clockwise direction during the downswing phase changes in a reverse direction through wrist release after impact during a swing. Should all these swing phases match the average swing ranges previously stored, analysis of the newly accumulated swing data may begin. In embodiments, analysis may start immediately after the point of detecting the impact point. In some embodiments, particularly those utilizing speed measuring device 100, the swing calculation algorithm may not require separate detection of the swing sensing stage. Rather, when golf ball 12 may be hit with golf club 10, whether physically or virtually, the swing may be recognized by monitoring head speed of golf club 10 and/or ball speed of golf ball 12 simultaneously, and thereby may achieve more accurate results.

After successfully recognizing a golfer's swing that has matched the four swing phases, the swing calculation algorithm may calculate positional displacement of a clubface and/or club path of golf club. In embodiments, when an impact may be detected, positional displacement of the stored data may be calculated. This positional displacement may be made through various mathematical calculations known in the art, including various correction calculations such as, without limitation, Kalman filter. For example, the positional displacement calculations may comprise a step of integrating measured acceleration to calculate to velocity results, and further may comprise a step of integrating the velocity results to calculate position results. In embodiments, the positional displacement may all be calculated based on a head of golf club 10, with adjustments being made based on the installation position of motion measuring device 200 and/or speed measuring device 100. Further, the positional displacement may be calculated based on average club length according to the type of golf club 10. For instance, when a user enters or provides information about golf club 10 (e.g., length and/or type) into the golfing analysis system, more accurate positional displacement results may be obtained.

In embodiments, the calculation positional displacement may comprise calculating clubface movement. For instance, calculating the position at setup and the position at impact may allow for the determination of how open or closed a clubface may be. However, since resolution of IMU sensor of motion measuring device 200 may be low and since detecting point of impact may be difficult, average clubface movement values in a specific impact section may be calculated and compared with reference average clubface movement values. In embodiments, these calculations may not calculate actual clubface angle or movement; but rather may calculate how much golf club 10 moves in a closed or open state. In further embodiments, positional displacement of club path in the process of moving from the setup posture position to the backswing may be detected. This may allow for calculation of a club path of golf club 10, which may determine whether the club pass may be IN-OUT or OUT-IN. Once again, this calculation may be compared and calculated as an average in the impact section. In embodiments, the left and right direction and spin of golf ball 12 may be calculated using the above calculate clubface angles and club path.

Further, after successfully recognizing a golfer's swing that has matched the four swing phases, the swing calculation algorithm may calculate ball trajectory. In embodiments, an important ball speed to recognize when calculating the trajectory of golf ball 12 may be the absolute velocity of motion measuring device 200 at impact, which calculates head speed of golf club 10 linearly for each club based on a distance to the head for each club. In embodiments, velocity of golf ball 12 may be calculated based on the assumption that golf ball 12 was struck at a center of golf club 10. An up and down angle of golf ball 12 for the ball trajectory may be calculated through a loft and angle of entry at impact of golf club 10. Further, the ball trajectory may be realized through a physics engine as a final side spin. In embodiments, in which speed measuring device 100 is combined, the velocity of golf ball 12 may be directly detected.

In some embodiments, with regard to data transmission and fast response processing, the above positional displacement calculation may be completed quickly before the follow-through swing phase, and all the calculated data may be transmitted to a connected external application 300 to quickly obtain the ball trajectory and swing results. Alternative third-party sensors may have a very slow response rate because data may be sent to and calculated by external application 300. However, the embodiments described herein may visualize ball trajectory and swing results with external application 300 faster, since such embodiments may transmit only the results calculated by the motion measuring device 200 and/or speed measuring device 100. Thus, the golfing analysis system may deliver a more realistic experience compared to other technologies.

In some embodiments, all results calculated by motion measuring device 200 and/or speed measuring device 100 may depend on the type of golf club 10, the golfer's swing type, and the position of motion measuring device 200 and/or speed measuring device 100. For instance, when sensing a fixed robot, the golfing analysis system may yield the same results with only minor correction being required. However, in the case of a real person, calibration may be required because every person has different conditions. In embodiments, maximum velocity point may vary according to classification of a player's swing, such as a swinger/power hitter; and in this case, calibration may be performed to move the maximum velocity point and/or impact point. In embodiments, face angle, club path, and head speed may all be adjusted.

In embodiments utilizing speed measuring device 100, speed measuring device 100 may be capable of detecting an impact point quickly and accurately. Further, speed measuring device 100 may deliver the impact point data to IMU sensor 250 of motion measuring device 200 while IMU sensor 250 and the speed measuring device 100 are connected through Bluetooth Low Energy communication. Therefore, speed measuring device 100 may be capable of delivering a reference time for calculating impact point while minimizing the calibration necessary for a user. By re-analyzing accumulated data with this reference time, it may possible to predict the impact point more accurately than calculating the impact point with IMU sensor 250 alone. Further, this process may not require microprocessor 230 to increase in size, making detection of the impact point possible with a low-resolution microprocessor 230.

In further embodiments; the golfing analysis system may employ artificial intelligence to combine radar frames from the speed measuring device 100 for highly accurate detection of, ball speed, club head speed, and launch direction and angle, and further to optimize an algorithm for side-spin, dynamic loft, face angle, and path angle in tandem with motion measuring device 200. In addition, sufficient image quality from the speed measuring device 100 may improve any launch angle calculations, which may rely on an assumed average loft of golf club 10. As an example, when average loft may be known, and the approximate launch angle may be measured, an algorithm may be employed to estimate dynamic loft, which, in turn, may increase accuracy of back-spin and distance traveled calculations.

The golfing analysis system, in addition to embedded motion logic algorithms, will employ artificial intelligence and or machine learning (either within embedded electronics, externally, or both) to relationally encode specific user movement patterns to activity states (i.e., address, backswing, top swing, down swing, impact, and follow-through) and help provide an additional layer for output data calculation improvement.

At address (i.e., initial position), and other important motion analysis benchmark waypoints, the sensor package(s) may at any time (in either a static or dynamic system) be electronically zeroed prior to recording and analyzing motion from that initial x,y,z coordinate. As such, the golfing analysis system may allow for an offset feature to correct for various hand positions of a plurality of different operators.

All aforementioned embodiments of the present invention may provide various benefits and features. For example, embodiments may be novel when combining 3-axis acceleration sensor 210, 3-axis gyroscope sensor 220, and radar-based equipment, thereby executing sensing activities with all equipment, in parallel, to detect movements in a sporting activity, particularly golfing. Furthermore, the golfing analysis system may provide the ability to automatically record a swing and register the swing as a practice swing, or a swing with impact of a golf ball, thus allowing the device to automatically record a stroke for score keeping and post round analysis.

Although the present invention and its advantages have been described in detail, it should be understood that various changes, substitutions and alterations may be made herein without departing from the spirit and scope of the invention as defined by the appended claims.

What is claimed is:

1. A system capable of analyzing objects and body movement, comprising:
a motion measuring device comprising an inertial measurement unit (IMU), a microprocessor, and a communications unit, wherein the motion measuring device is disposed on an operator or operator's equipment;
a speed measuring device comprising a radar sensor, a camera sensor, a remote GPS sensor, and a display unit, wherein the speed measuring device is disposed at a distance from the operator and the motion measuring device; and
an external application.

2. The system of claim 1, wherein the IMU comprises an acceleration sensor and a gyroscope sensor.

3. The system of claim 1, wherein the IMU is configured to measure acceleration values of the motion measuring device, the operator, and/or the operator's equipment along three axes in space.

4. The system of claim 1, wherein the IMU is configured to measure rotational speed values of the motion measuring device, the operator, and/or the operator's equipment along three axes in space.

5. The system of claim 1, wherein the microprocessor employs algorithms on measurements obtained by the IMU to provide various metric values.

6. The system of claim 5, wherein the various metric values comprise swing distance, tempo, club path direction, club path, face angle direction, face angle, swing type, sensor speed, a face angle value, and ball speed.

7. The system of claim 5, wherein the various metric values are transmitted via the communications unit to an external application.

8. The system of claim 1, wherein the communications unit is a wireless communication system utilizing radio, Bluetooth, and/or Wi-Fi.

9. The system of claim 1, wherein the speed measuring device further comprises a second microprocessor and a second communication unit.

10. The system of claim 1, wherein the radar sensor is a single or multi-channel radar.

11. The system of claim 1, wherein the radar sensor is configured to measure velocity values of the operator, and/or the operator's equipment.

12. The system of claim 1, wherein the speed measuring device provides loft values, coefficients of energy return, golf club type, distance value.

13. The system of claim 1, wherein the camera sensor captures images and records videos of the operator, and/or the operator's equipment.

14. The system of claim 1, wherein the external application is a simulation device.

15. The system of claim 1, wherein the external application is configured onto a mobile device, smartphone, tablet, laptop computer, or personal computer with external monitor.

16. The system of claim 1, wherein the motion measuring device and the speed measuring device work in conjunction to provide various metric values.

17. The system of claim 1, further comprising a database for storage of measured values.
